(19) United States
(12) Patent Application Publication
(10) Pub. No.: US 2024/0365040 A1
(43) Pub. Date: Oct. 31, 2024

(54) Headphone Conversation Detect

(71) Applicant: Apple Inc., Cupertino, CA (US)

(72) Inventors: Ashok Masilamani, San Diego, CA (US); David M. Fischer, San Francisco, CA (US); John Woodruff, San Jose, CA (US); Jonathan D. Sheaffer, San Jose, CA (US); Sanket S. Dave, Sunnyvale, CA (US); Deepak Iyer, Mountain View, CA (US); Andrew W. Malta, San Francisco, CA (US); Erik D. Hornberger, Pittsburgh, PA (US)

(21) Appl. No.: 18/622,543

(22) Filed: Mar. 29, 2024

Related U.S. Application Data
(60) Provisional application No. 63/499,180, filed on Apr. 28, 2023.
(60) Provisional application No. 63/499,174, filed on Apr. 28, 2023.

(51) Int. Cl. H04R 1/10; G10K 11/00; G10L 21/0208; G10L 21/028; G10L 25/84; H04S 7/00

(52) U.S. Cl. CPC H04R 1/1016; G10K 11/002; G10L 21/0208; G10L 21/028; G10L 25/84; H04S 7/304; H04R 2460/13; H04S 2400/15

(57) ABSTRACT

A conversation detector processes microphone signals and other sensor signals of a headphone to declare a conversation and configures a filter block to activate a transparency audio signal. It then declares an end to the conversation based on processing one or more of the microphone signals and the other sensor signals, and in response deactivates the transparency audio signal. The conversation detector monitors an idle duration in which an OVAD and a TVAD are both or simultaneously indicating no activity and declares the end to the conversation in response to the idle duration being longer than an idle threshold. Other aspects are also described and claimed.

This nonprovisional patent applications claims the benefit of the earlier filing dates of U.S. provisional application Nos. 63/499,174 and 63/499,180 both filed 28 Apr. 2023.

### FIELD

An aspect of the disclosure here relates to digital audio signal processing techniques that reduce the effort by a person who is wearing headphones, of having a conversation with another person in a noisy ambient sound environment. Other aspects are also described and claimed.

### BACKGROUND

Having a conversation with someone who is nearby but in a noisy environment, such as in a restaurant, bar, airplane, or a bus, takes effort as it is difficult to hear and understand the other person. A solution that may reduce this effort is to wear headphones that passively isolate the wearer from the noisy environment but also actively reproduce the other person's voice through the headphone's speaker. This is referred to as a transparency mode of operation. In one type of transparency mode, selective reproduction of the ambient sound environment takes place, by applying beamforming signal processing to the output of a microphone array in the headphones. This focuses sound pickup in the direction of arrival of the voice of a talker (de-emphasizing or suppressing the pickup of ambient sound in other directions.) Such headphones may also have an acoustic noise cancellation (ANC) mode of operation in which a quiet listening experience is created for the wearer by electronically cancelling any ambient sounds that would otherwise still be heard by the wearer (due to having leaked past the passive sound isolation of the headphones).

### SUMMARY

The selective reproduction of a headphone wearer's ambient sound, by digital signal processing of the signals produced by the microphones of the headphone as part of a transparency mode of operation, may be designed to make it easier for the wearer to hear and understand another person (for example in the same room) with whom they are in a conversation. There is however some risk that such signal processing will not be able to achieve that goal, which leads to an unpleasant listening experience for the headphone wearer when the transparency mode is activated. This may be due to the transparency mode being activated at the wrong time, or deactivated at the wrong time, thereby reproducing undesirable ambient sounds.

An aspect of the disclosure here is a signal processing technique referred to as a conversation detector or conversation detect process. The conversation detector is a digital signal processing technique that operates upon one or more external microphone signals of the headphone, and perhaps one more other sensor signals such as produced by an audio accelerometer or bone conduction sensor, to decide when to activate or trigger a transparency mode of operation, and it ideally should be active only during an actual conversation between a wearer of the headphone and another talker in the same ambient environment. The talker (referred to here as “other talker”) is a person who is nearby for instance within two meters of the headphone wearer. The other talker may be standing next to or sitting across a table or side by side, for instance in a dining establishment, in the same train car, or in the same bus as the wearer. In one aspect, the transparency mode activates a conversation-focused transparency signal processing path (C-F transparency) in which one or more of the microphone signals of the headphone are processed to produce a conversation-focused transparency audio signal which is input to a speaker of the headphone. The conversation detector may declare the conversation has ended more accurately than relying solely on the absence of own voice activity. To declare the conversation ended, the conversation detector may implement an own voice activity detector, OVAD, and a target voice activity detector, TVAD whose inputs are one or more of the microphone signals and when available one or more other sensor signals. The OVAD and the TVAD detect own-voice activity (the wearer is talking) and far-field target voice activity (the other talker is speaking.) The conversation detector monitors a duration in which the OVAD and the TVAD are both or simultaneously indicating no activity and may declare the end of the conversation in response to the duration being longer than an idle threshold.

The conversation detector thus helps not only reduce power consumption, which is particularly relevant in wireless headphones, but also reduce the instances of distortion that might be introduced by the conversation-focused transparency signal processing path. It can advantageously prevent the mode being activated in unsuitable situations.

In one aspect, the conversation-focused transparency audio signal is different than a normal transparency audio signal that is also routed to drive the speaker, where the latter may or may not have been active prior to a conversation-focused mode being activated. In another aspect, an ANC path may have been active before activation of the conversation-focused mode, producing an anti-noise signal that was being routed to the headphone speaker. This anti-noise signal may have accompanied the normal transparency audio signal, or it may have been active by itself (without the normal transparency audio signal).

A filter block produces the conversation-focused transparency audio signal by enhancing or isolating the speech of the other talker. It may be performed in many ways, e.g., by processing two or more external microphone signals (from two or more external microphones, respectively) of the headset using sound pickup beamforming to perform spatially selective sound pick up in a primary lobe having an angular spread of less 180 degrees in front of the wearer. It may be performed using knowledge based statistical or deterministic algorithms, or it may be performed using data driven techniques such as machine learning (ML) model processing, or any combination of the above.

In one aspect, when the conversation detector declares an end to the conversation, then at that point the transparency mode is deactivated. That means, for example, deactivating the conversation-focused transparency audio signal. In one aspect, the transparency mode is deactivated by also activating an anti-noise signal (or by raising selected frequency-dependent gains of, or raising the scalar gain of, the anti-noise signal.) In other aspects, entering and exiting the transparency mode during media playback (e.g., music playback, movie soundtrack playback) changes how the media playback signal is rendered.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 depicts an example of a headphone wearer who is trying to listen to another talker in their ambient sound environment.

FIG. 2 is a block diagram of a headphone having digital audio signal processing that implements a transparency mode of operation for the headphone in which the wearer's speech listening effort is advantageously reduced.

FIG. 3 is a block diagram of an example conversation detector.

FIG. 4 is a diagram of another example conversation detector.

FIG. 5 illustrates how an example conversation detector declares a conversation based on matching target speaker identification models that have been produced for respective portions of a microphone signal.

FIG. 6 shows a multi-stage false trigger sound detector that prevents the conversation from being declared.

FIGS. 7a-7d illustrate how a sound pick up aperture of a conversation detector expands and shrinks in response to yaw angle changes in the headphone wearer's head.

FIG. 8 is a flow diagram of an example method in which the conversation-focused transparency audio signal is produced based on the recommended aperture.

FIGS. 9a-9c illustrate an example method that creates and monitors a pedestrian boundary around the wearer upon the conversation being declared.

### DETAILED DESCRIPTION

Several aspects of the disclosure with reference to the appended drawings are now explained. Whenever the shapes, relative positions and other aspects of the parts described are not explicitly defined, the scope of the invention is not limited only to the parts shown, which are meant merely for the purpose of illustration. Also, while numerous details are set forth, it is understood that some aspects of the disclosure may be practiced without these details. In other instances, well-known circuits, structures, and techniques have not been shown in detail so as not to obscure the understanding of this description.

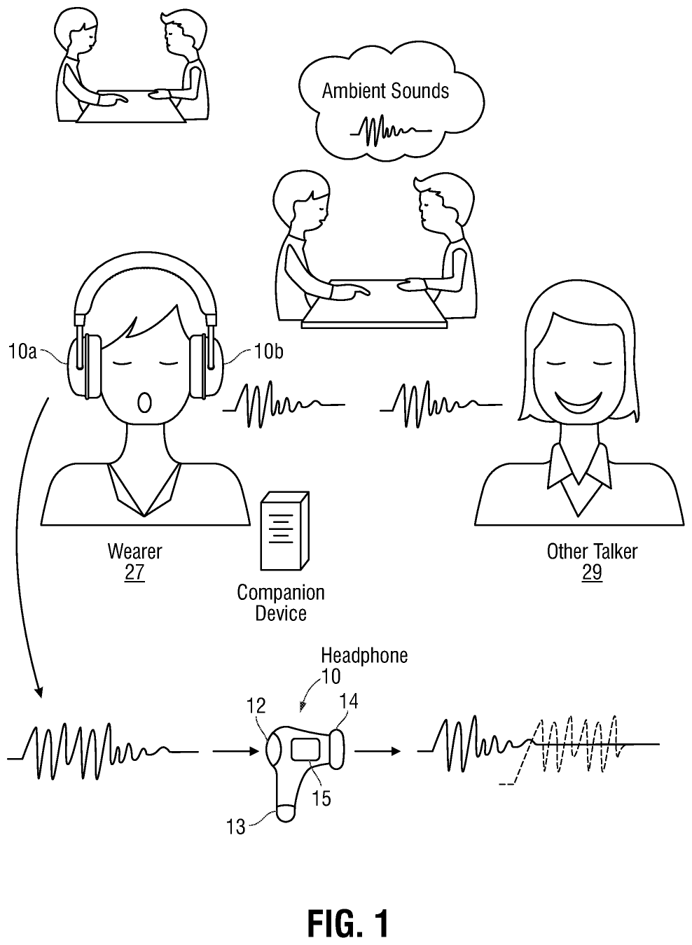

FIG. 1 depicts an example of a headphone wearer's listening experience in a noisy ambient sound environment. The wearer 27 is a person who is carrying on a conversation with another person (other talker 29) who is nearby live or in the same ambient environment within normal human hearing distance, e.g., in the same room. At the same time there is undesired ambient sound that would be heard by the wearer such as non-speech sounds and, in the example depicted, speech by other persons who are also talking but are farther way. This might be a conversation in a restaurant, bar, airplane, or a bus, which takes effort as it is difficult for one person to hear and understand even a nearby talker. A solution that may reduce this effort is to wear a headphone 10 that not only passively isolates the wearer 27 from the noisy environment but also actively reproduces desirable or target ambient sounds such as speech or voice of the other talker 29, in a so-called transparency mode of operation. The headphone 10 may be a primary headphone 10a or a secondary headphone 10b that together form a headset, where the terms primary and secondary are used to distinguish between the two headphones of a headset (and primary may refer to either the left headphone or the right headphone) and in some cases to define certain actions that are performed by one and not the other. The headphone 10 may be an earpiece of an over-the-car headset, an on-the-car headset, an in-ear headset (also referred to as earbuds, which may be loose fitting or acoustically sealing.) The term headphone is used generically here to refer to any other against-the-car personal listening device.

The headphone 10 is part of an audio system that has a digital audio processor 15, two or more external microphones 12, 13, at least one internal microphone (not shown in the figure), and a headphone speaker 14, all of which may be integrated within the housing of the headphone 10. The internal microphone may be one that is arranged and configured to receive the sound reproduced by the speaker 14 and is sometime referred to as an error microphone. The external microphone 12 is arranged and configured to receive ambient sound directly and is sometimes referred to as a reference microphone. The external microphone 13 is arranged and configured to be more responsive than the other external and internal microphones in picking up the sound of the wearer voice and is sometimes referred to as a voice microphone.

In a transparency mode of operation, such a system actively reproduces the voice of the other talker 29 that has been picked up by the external microphones 12, 13, through the headphone speaker 14, while the processor 15 is performing signal processing for suppressing background noise or undesirable sounds. The transparency mode may be implemented separately in each of the primary headphone and the secondary headphone, using much the same methodology described below. The primary headphone may be in wireless data communication with the secondary headphone, for purposes of sharing control data that is transmitted over-the-air from a different instance of a conversation detector (described below) that is operating in the secondary headphone 10b. Also, one or both of the headphones may also be in wireless communication with a companion device (e.g., a smartphone, a tablet computer) of the wearer, for purposes of for example receiving from the companion device a user content audio signal (e.g., a downlink call signal, a media playback signal such as a mono media playback signal or a multi-channel media playback signal), sending an external or internal microphone signal to the companion device as an uplink call signal, or receiving control data from the companion device that configures the transparency mode (at least as to those portions that are performed in the headphone 10, noting that in some cases some of the operations of the transparency mode may be performed in the companion device).

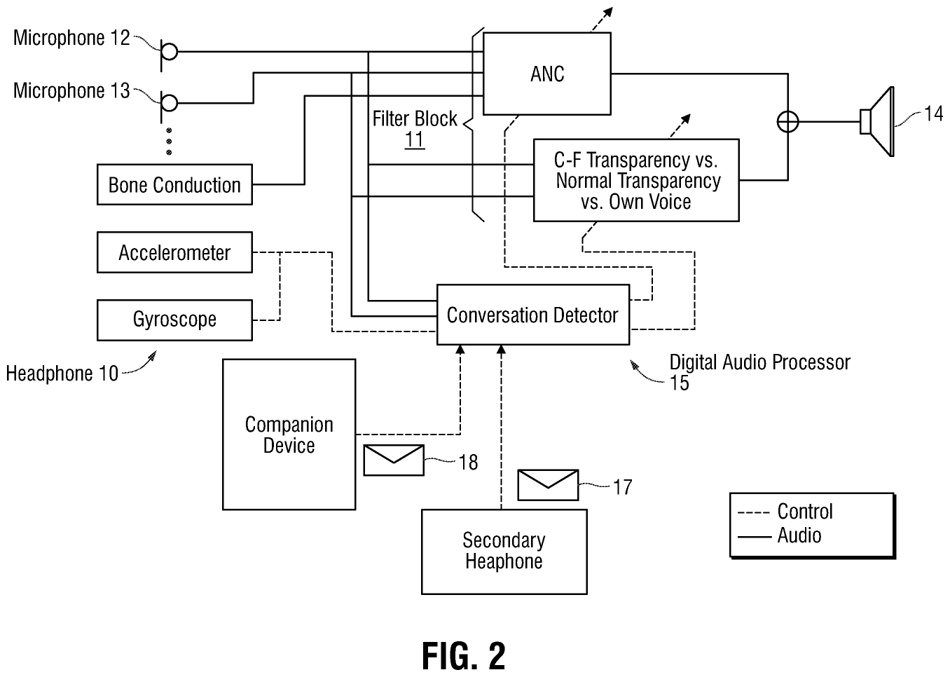

Referring now to FIG. 2, this is a block diagram of the headphone 10 illustrating how the digital audio processor 15 implements various digital signal processing tasks relating to the transparency mode of operation in which the wearer's speech listening effort during a conversation with the other talker 29 is advantageously reduced. Note the demarcation of the control and the audio signal paths.

The processor 15 has a filter block 11 through which one or more of the external microphone signals 12, 13 are processed before driving the speaker 14. The filter block is to process one or more of the microphone signals in the headphone, using various digital signal processing paths to produce one or more of the following audio signals. An anti-noise signal may be produced by an acoustic noise cancellation (ANC) subsystem, e.g., having a digital filter that is adaptively updated based on a feedforward ANC, feedback ANC or hybrid ANC arrangement to produce the anti-noise signal. A conversation-focused transparency audio signal may be produced by a C-F transparency signal processing path which may contain a digital filter that is configured to filter one or more of the microphone signals, where the digital filter may be a time-varying filter that is updated or adapted in real-time or on a per audio frame basis based on the processor detecting a far-field speech (or far-field target voice) in the microphone signals. More generally, the filter block 11 may implement any suitable digital processing of the two or more external microphone signals (from two or more external microphones, respectively) of the headset to produce the conversation-focused transparency audio signal, e.g., sound pickup beamforming, knowledge based statistical or deterministic algorithms, or data driven techniques such as machine learning (ML) model processing of one or more of the external microphone signals.

The processor 15 implements a conversation detector which controls automatically (without requiring explicit input from the wearer) when to activate and when to deactivate the transparency mode of operation, as well as when to enter other modes of operation described below (such as an own voice or sidetone mode.) It should declare a conversation when the wearer of the headphone is conversing with or is about to converse with another talker who is in an ambient environment of the wearer. It should end the conversation when the wearer has stopped conversing with the other talker. Still referring to FIG. 2, the conversation detector processes i) one or more of the microphone signals and ii) one or more other sensor signals such as a bone conduction sensor signal, an accelerometer signal, a gyroscope signal, or an image sensor signal (produced by a camera—not shown.) These sensor signals may be produced by hardware that is integrated within the headphone 10. The conversation detector processes these signals to declare a conversation, when the wearer of the headphone is conversing with or is about to converse with another talker who is in an ambient environment of the wearer.

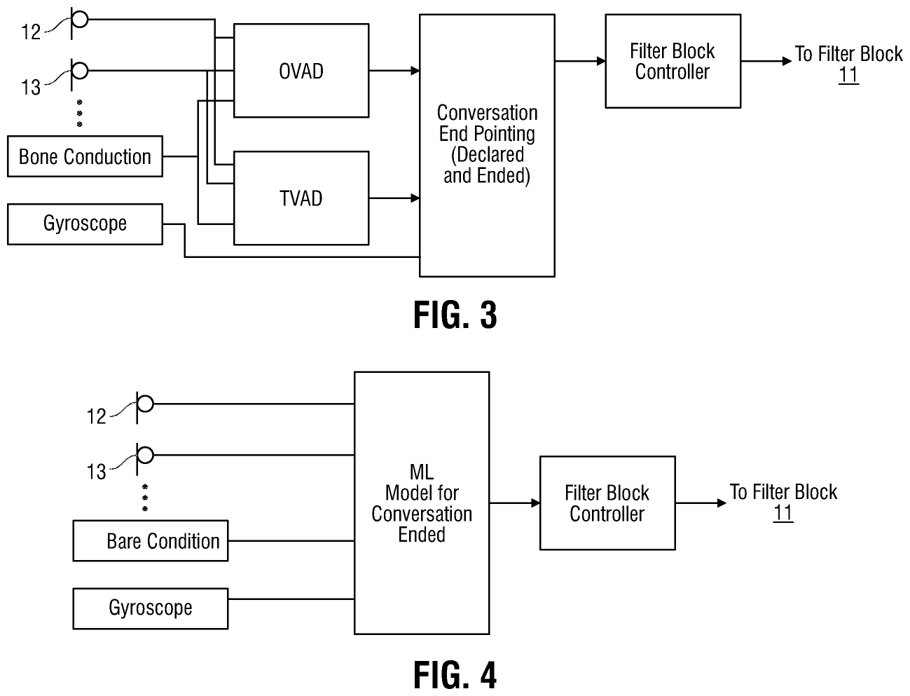

The conversation detector may declare the conversation has ended based on i) comparing a detected gap after a word in the own voice, to an own voice threshold and ii) comparing a detected gap after a word in the target voice (that of the other talker), to a target voice threshold. These gaps may be detected based on speech vs. non-speech activity outputs of an own voice activity detector (OVAD) and a target voice activity detector (TVAD) described further below in connection with FIG. 3. Separate thresholds may be defined for the own voice and the target voice. Also, the conversation detector updates the target voice threshold (as it may be stored in persistent or nonvolatile memory), based on determining a length of the conversation. One could define for example three types of conversations as short, medium, and long types with each type having a respective target voice threshold or a respective own voice threshold.

Still referring to FIG. 2, the processor 15 has several modes of operation. There is a conversation-focused transparency mode of operation, which should be triggered or activated only when the wearer 27 of the first headphone is conversing with or is about converse with the other talker 29 who is in an ambient environment of the wearer. There may also be an own voice mode of operation, which may be a sidetone mode of operation in which the filter block is configured with an own-voice digital signal processing path to primarily reproduce some of the wearer's own voice (routed through the speaker 14) to provide a more comfortable headphone experience when the wearer is talking.

As an alternate to the conversation-focused transparency and own voice modes, there may be a normal transparency mode of operation in which the filter block 11 is configured with a normal transparency digital signal processing path that produces a normal transparency audio signal. The normal transparency signal processing path may be configured to pass ambient sounds that have been picked up by the external microphone signals (and are reproduced through the speaker 14) without trying to enhance any far-field speech or without trying to suppress ambient sound pick up in a particular direction around the wearer. The normal transparency signal processing path may be considered to process the microphone signals to achieve an omnidirectional ambient sound pick up around the headphone, e.g., at least within an azimuthal plane through the headphone.

In some cases, the ANC subsystem may be active simultaneously with one of the transparency paths but primarily in a different audible frequency band, while both are feeding the speaker 14 simultaneously. Alternatively, the ANC may be active while the transparency path is entirely inactive, i.e., inactive across the entire audio spectrum, to produce a quiet listening experience. The conversation detector may decide when and how to configure these ANC and transparency signal processing paths (or transition between the various modes of operation).

When the transparency mode is activated, the processor configures the filter block 11 to activate the conversation-focused transparency audio signal and routes the conversation-focused transparency audio signal to the speaker 14 of the headphone. When the conversation ends (the wearer and the other talker have stopped talking to each other), the conversation detector should declare that the conversation has ended in response to which the conversation-focused transparency audio signal is deactivated. The conversation detector may do so based on processing one or more of the microphone signals and the other sensor signals as described in more detail below.

The task of when and how to declare the conversation has ended is addressed first. In one aspect, the conversation detector performs machine learning (ML) model based monitoring of the wearer's voice (own voice) and that of another talker, using the microphone and other sensor signals as input, to declare the end of the conversation. This is depicted in FIG. 4 where the output of the ML model directly declares the conversation end. This is input to a filter block controller, and the latter in response configures the filter block 11 as was described above in the appropriate mode of operation. For instance, in response to declaring the conversation has ended, the transparency mode is deactivated by deactivating the conversation-focused transparency audio signal. In some cases, an anti-noise signal may also be activated or re-activated, or the scalar gain of the anti-noise increased, or the frequency-dependent gains of the anti-noise are increased. That in turn provides a quiet listening experience for the headphone wearer particularly when the increased ANC is combined with simultaneous deactivation of the conversation-focused transparency audio signal.

FIG. 3 depicts a solution in which the conversation detector contains two voice activity detectors, VADs, an own voice VAD (OVAD) and a target or other talker VAD (TVAD.) Each VAD may provide as its output a sequence of instances of binary, speech vs. non-speech determinations. Each instance may correspond to a separate window or time interval (where adjacent windows may have some overlap with each other) of the input microphone and other sensor signals. These outputs feed a conversation end pointing process that monitors a duration in which the OVAD and TVAD are both or simultaneously indicating non-speech (or no speech activity.) The conversation is declared as ended in response to the duration being longer than an idle threshold.

In accordance with an adaptive tuning aspect, the idle threshold (for when to declare the conversation as ended) may be varied, as follows. The conversation end pointing process of FIG. 3 tracks the instances over time of an observed idle duration. Each instance of the observed idle duration is a length of time that the transparency mode remains continuously inactive until it is activated in response to the TVAD or the OVAD indicating speech activity. The process may monitor the observed idle duration over a period of days or weeks, for example, and automatically varies or updates the idle threshold based on the observed idle duration.

Another aspect of the disclosure here relates to the processor buffering one or more of the microphone signals as “past ambient audio” and routing the past ambient audio to the speaker 14 while the conversation detector is processing the microphone signal to declare the conversation or declare the conversation has ended. For example, the last one second of ambient audio just prior to the conversation being declared may always be buffered and routed through the speaker 14, so that the wearer can hear the ambient sounds just prior to any change in the mode of operation (e.g., when transitioning from transparency to ANC mode).

In one aspect, the processor is configured to buffer and process one or more of the microphone signals for detecting far-field speech. So long as no far-field speech is detected, the transparency mode remains deactivated, and then is activated in response to far-field speech being detected.

Turning now to the task of how to declare the conversation (has started), one approach is to simply react to the OVAD output indicating (speech) activity. In one aspect, the processor also implements a false trigger detector that prevents the conversation from being declared (despite the OVAD output indicating speech activity), by processing one or more of the microphone signals and the other sensor signals to detect a false trigger sound. The false trigger sound could represent chewing, sneeze, cough, yawn, or burp by the wearer of the headphone. These are examples of nonverbal vocalizations that do not resemble speech. The false trigger sound could alternatively represent loud breath, loud sigh, face scratch, walking, or running by a wearer of the headphone. In yet another example, the false trigger sound represents the wearer of the headphone talking to themselves or singing a song to which they are listening. In still another example, the false trigger sound represents sound from a source that is in a far-field of the external microphones but that is not speech. If such a false trigger sound is detected, then the conversation is not declared. The false trigger detector may be implemented as depicted in FIG. 6.

Referring now to FIG. 6, the false trigger detector is configured with several stages of digital audio processing. In a first stage, one or more of the microphone signals and the bone conduction sensor signal are processed to set a first flag, Own Voice yes/no, that indicates whether a detected sound is the wearer of the headphone talking. In a second stage, the first flag and one or more of the microphone signals or the bone conduction sensor signal are processed to set a second flag that indicates whether the detected sound is either verbal vocalizations or non-verbal vocalizations (e.g., laughter, sobbing, screaming.) And in a third stage, the second flag and one or more of the microphone signals are processed to set a third flag based on analyzing the detected sound for far-field activity. If the third stage determines that the detected sound is from a far-field source, then the third stage asserts the third flag indicating that the detected sound is a false trigger sound.

It should be noted that FIG. 6 is one of several possibilities to determine if the wearer spoke. A single stage ML model may be developed that receives as input one or more of the microphone signals and other sensor signals and provides as output the probability that speech is detected. Such an ML model could have been trained with cough, sneeze or other non-speech sounds as negatives.

In one aspect, when the false trigger detector prevents the transparency mode from being activated and the second flag indicated the detected sound is a verbal vocalization, the conversation detector configures the filter block 11 (see FIG. 2) into an own voice digital filter that produces an own voice or sidetone audio signal which is routed to the speaker 14.

Returning momentarily to FIG. 2, the conversation detector may be instantiated twice, a first instance executing in the primary headphone and a second instance in the second headphone (left and right pair) of a headset worn by the wearer. The first instance of the conversation detector may be configured to receive a message 17 about a second false trigger sound that has been detected by the second instance, where the two false trigger sounds cover the same time interval. If the first false trigger sound is consistent with the second false trigger sound, the first instance of the conversation detector sets an agreement flag, and if inconsistent then it sets a disagreement flag. This additional information may be used by the first instance of the conversation detector to increase confidence in its decision to prevent the conversation from being declared.

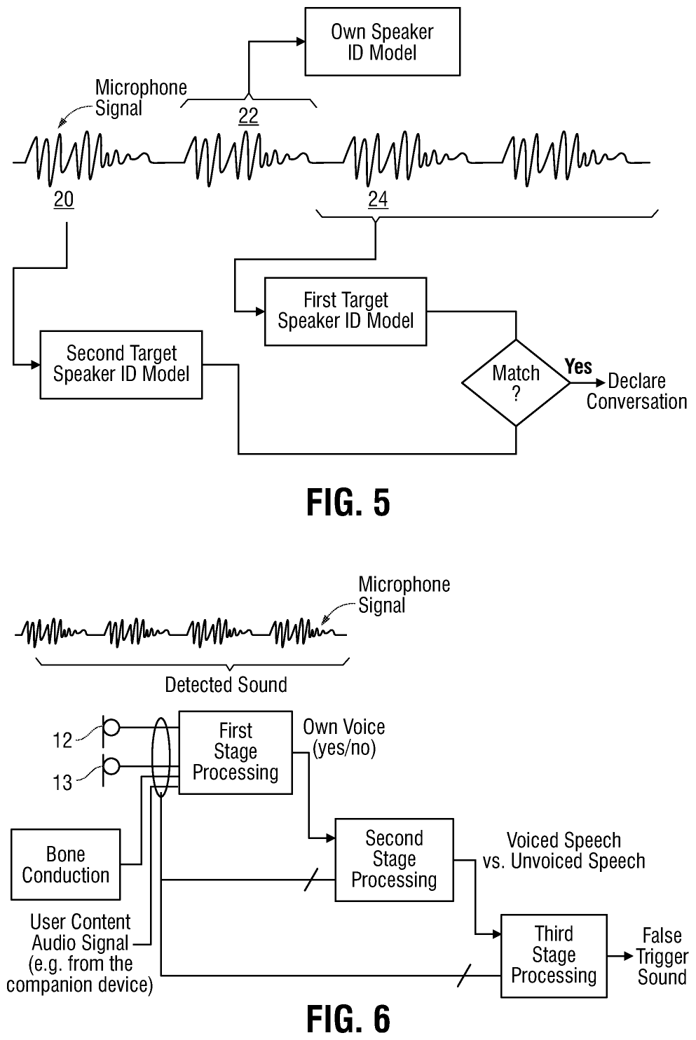

Turning now to FIG. 5, this is a block diagram of an example of the conversation detector that uses speaker identification models to decide when to declare the conversation. In one aspect here, when a different voice that follows (in time) the own voice is detected, the processor assumes it is that of the other talker 29 (also referred to as a target voice or target speech.) The processor characterizes this voice snippet through a speaker identification model (speaker ID model), and stores that characterization as a voice print. The processor then compares the stored voice print to future voice snippets, to declare a conversation without relying on the yaw angle of the headset or the direction in which the wearer is looking at that time. Such a speaker ID algorithm-based solution addresses two problem situations in which knowing which direction the headset wearer is looking is not enough (to accurately declare the conversation), namely when the headset wearer is talking to a person in front of wearer but there is another sound source behind the other person like a tv or other talkers, and when the headset wearer is talking to a person who is not in front in them, e.g., sitting next to them on a bus or an airplane.

Each speaker ID model can determine in real time, based on for example the activity vs. inactivity output of the TVAD—see FIG. 3—the conversation characteristics or parameters of the other talker whose voice is present in the ambient sound pick up (as in one or more of the external microphone signals.) These parameters may represent a conversation signature and can be used to “identify” in real-time the other talker the next time the headphone wearer is having a conversation with that same talker. In this manner, different talkers who have conversations with the headphone wearer over time are identified by their conversation characteristics or parameters, which are stored for later use. Examples of such parameters include gaps or pauses between words detected by the TVAD, which are monitored by the processor 15 to generate a conversation signature for another talker. A conversation signature may also be generated for the wearer, based on monitoring gaps between words as detected using the OVAD output. Each conversation signature may describe the gaps between words spoken by the wearer, or by the other talker, during a conversation the wearer is having with another talker. Each time the wearer has a conversation with someone, a new conversation signature may be generated for another talker, and a new one may also be generated for the wearer. All conversation signatures (one or more for the wearer, one or more for talker A, one or more for talker B, etc.) may be associated with the headphone wearer and stored in a companion device's operating system, or they may be stored in other persistent data storage such as inside the headphone, for later use by the conversation detector.

Back to FIG. 5, this figure depicts an example of how the processor 15 of FIG. 2, and its conversation detector can process a first portion 22 of one or more of the microphone signals, using a speaker identification algorithm to produce an own speaker ID model. As explained above, the own speaker ID model may contain one or more conversation signatures of the wearer. Similarly, the conversation detector also produces a first target speaker ID model, which is based on a second portion 24 of the one or more microphone signals. The conversation detector also produces a second target speaker ID model, that one based on a third portion 20 of the one or more microphone signals. Armed with these models, the conversation detector declares a conversation based on comparing the second target speaker ID model with the first target speaker ID model to find that the second target speaker ID model matches the first target speaker ID model, and in response activates the transparency mode. And as explained above, in one instance, when the transparency mode is activated, the processor signals the filter block 11 (see FIG. 2) to i) deactivate or reduce selected frequency-dependent gains or reduce a scalar gain of the anti-noise signal and ii) activate the conversation-focused transparency audio signal and routes the conversation-focused transparency audio signal to the speaker 14 of the headphone. Note that in the example shown in the figure, the second portion 24, in its entirety, is later in time than the first portion 22, while the third portion 20, in its entirely, is earlier in time than the first portion 22.

In another aspect, the conversation detector may declare the conversation based on an output of a VAD (e.g., the OVAD) indicating speech activity. The VAD receives as input the one or more microphone signals and the bone conduction signal and provides as output a sequence of instances of speech vs. non-speech, for a sequence of instances of a window, respectively, wherein the window is longer than any single syllable duration. The window may have a duration of at least any two consecutive syllables. The window may be longer than one hundred milliseconds and shorter than three hundred milliseconds. In another aspect, the conversation detector declares the conversation based on a heuristic-model based speech detector or an automatic speech recognition machine learning model, both configured to receive as input the one or more microphone signals and other sensor signals and provide an output that differentiates spoken voice syllables from other sounds.

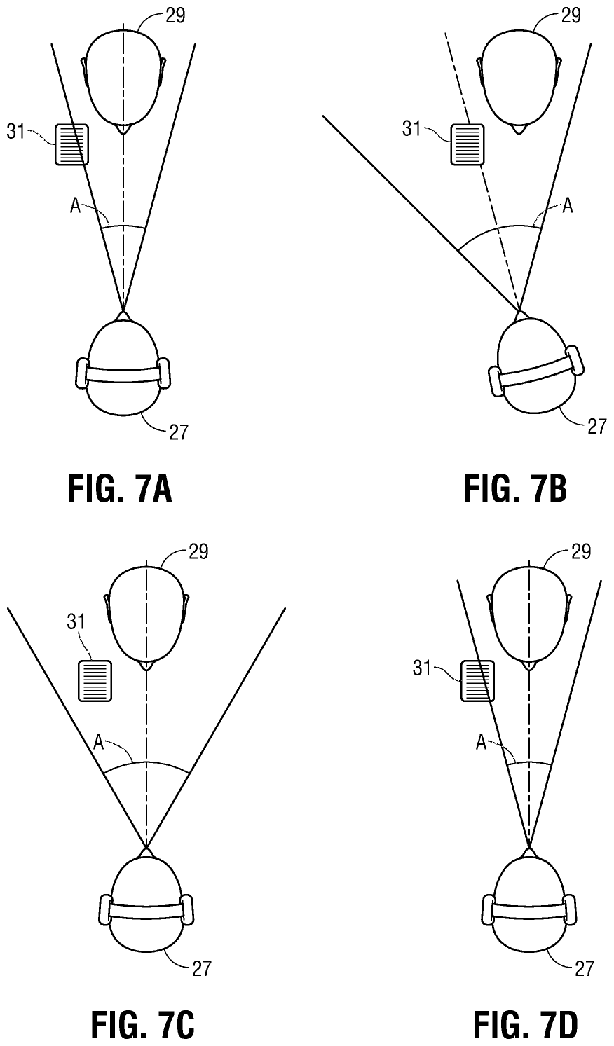

Having described several ways in which the conversation detector can declare and end the conversation, another aspect of the system of FIG. 2 is now described as a method for headset audio processing, of how to produce the conversation-focused transparency audio signal while operating in a transparency mode. This aspect is also referred to here as a motion-tracked auditory viewpoint and is described using the example diagrams of FIGS. 7a-7d. In such a method, the processor 15 is configured to generate a recommended aperture, A, while the wearer of the headset is looking in a first direction. In the example of FIG. 7a, the first direction is indicated by a front axis which is a dotted, straight line from the wearer 27 extending straight ahead of the headset. The font axis in this case intersects with the head of the other talker 29. The other talker 29 may be for example a person taking the wearer's food order at a restaurant, while a food menu appears on a nearby display 31.

The recommended aperture A represents an angular spread or sector that extends in front of and outward from the headset (worn by the wearer 27), between a beginning direction and an ending direction. Spatially selective sound pickup (e.g., beamforming), speech enhancement, or speech isolation/speech separation is performed, based on or within the recommended aperture A, by appropriately configuring the filter block 11 to process at least two of the external microphone signals (that are produced by at least two external microphones in the headset.) As an example, a beamforming algorithm may be performed that suppresses sound pickup in directions that are outside of the recommended aperture. As another example, processing the microphone signals comprises using an ML model to perform speech enhancement or speech separation. In these cases, this results in the voice of the other talker 29 being isolated or enhanced in the conversation-focused transparency audio signal, which may also encompass suppressing incoming sound from outside of the recommended aperture A.

Next, the processor expands the recommended aperture in response to the wearer of the headset looking away from the first direction in a different, second direction. A yaw angle sensor in the headset may be used to sense such changes of direction. The situation is depicted in FIG. 7b where the wearer has looked to their left, now directly at the food menu being shown on the display 31, and the recommended aperture A has expanded to cover not only the first direction but also the second direction. In particular, the spread angle in FIG. 7b now covers some additional amount to the left of the newly located front axis.

Next, the wearer immediately turns to their right, towards the other talker 29, as seen in FIG. 7c. Here, the recommended aperture A has retained the spread angle it had in FIG. 7b, because the wearer immediately turned back toward the other talker 29 after looking away. Now, if the wearer continues to look towards the other talker 29 or does not change the direction in which they are looking, then the processor starts to shrink the recommended aperture A. This shrinking continues so long as the wearer continues to look in the same direction (or does not look in a different direction)—this is depicted in FIG. 7d where the recommended aperture A has shrunk back to its initial spread angle in FIG. 7a.

In one aspect, the recommended aperture shrinks according to a decay parameter, which may be the rate at which the recommended aperture shrinks from a previous instance of the recommended aperture, e.g., a time constant. Thus, while expanding the aperture may occur immediately (in response to the wearer looking in a different direction), its shrinking occurs gradually while the wearer continues to look in the same direction.

The recommended aperture may be a sequence of instances over time where each instance is generated based on a yaw angle history, a previous instance of the recommended aperture, and the decay parameter. The yaw angle history comprises several instances over time of sensed yaw angle of the headset and may be stored in memory within the headset.

In another aspect, the recommended aperture can be expanded to one of only a handful of predetermined apertures. Thus, rather than allow the recommended aperture to be expanded to every value, only a limited number of predetermined, different apertures (and their associated beamforming algorithms) are permitted, which may be beneficial when constrained by computing or memory resources in the headset.

In another aspect, expanding the recommended aperture comprises using an ML model to analyze the yaw angle history of the headset to determine not only when to expand the recommended aperture but also by how much.

In yet another aspect, expanding the recommended aperture is in response to the processor detecting a head tilt by the wearer, which may suggest that the other talker 29 is sitting or standing to the side of the wearer (rather than directly in front as depicted in FIG. 7a.).

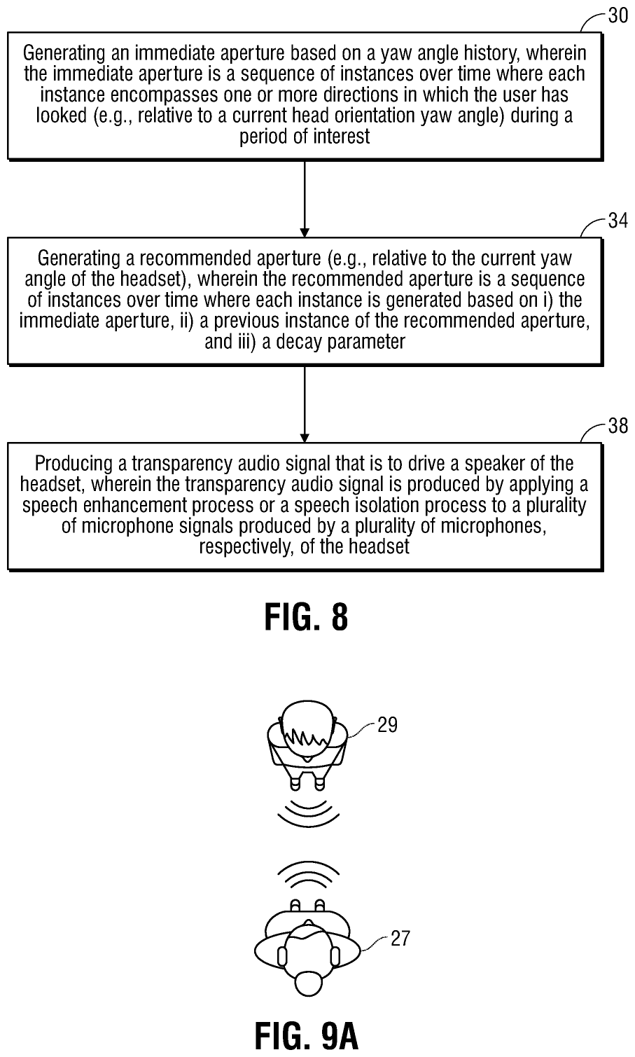

FIG. 8 is a block diagram of an example method for headset audio signal processing, in which the conversation-focused transparency audio signal is produced based on the recommended aperture. The method includes the operations 30, 34 and 38 shown in the figure, which result in the recommended aperture being a variable that changes in the manner described above and illustrated in FIGS. 7A-7D while the headset is in a transparency mode of operation. For instance, the recommended aperture expands immediately whenever the user looks in a different direction to encompass the different direction, and otherwise (while the user is not looking in different directions) shrinks at a rate that is in accordance with the decay parameter. In another instance, the recommended aperture shrinks due to one or more old directions not being included in the recommended aperture, wherein the old directions are directions in which the user has looked prior to the period of interest. The period of interest looks back in time, from the present instance, e.g., 3 seconds back from the present.

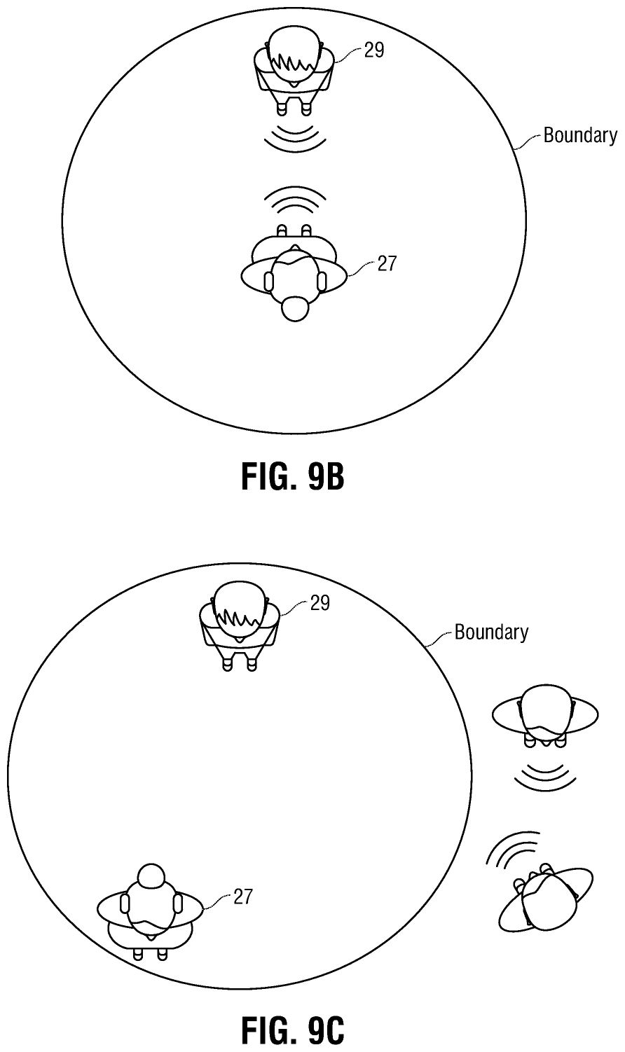

Turning now to FIGS. 9a-9c, these figures illustrate an example pedestrian fence or boundary, which is created around the wearer 27 upon the conversation being declared. The figures show an example where the wearer and the other talker are in loud or crowded environment (indicated by the presence of more talkers nearby.) The boundary is used by the processor as part of a method for determining when to declare the conversation ended. The method begins in FIG. 9a with processing i) one or more of the microphone signals produced in the headphone worn by the wearer, and ii) one or more other sensor signals such as a bone conduction sensor signal, an accelerometer signal, a gyroscope signal, or an image sensor signal in the headphone, to detect an own voice (a voice that is believed to be that of the wearer 27.) The OVAD may be used for this purpose. In response to detecting in the own voice that the wearer 27 is talking, a transparency mode of operation (e.g., one in which the conversation-focused transparency audio signal is produced) is activated.

Next, the conversation-focused transparency audio signal is adjusted based on the OVAD indicating activity and based on the TVAD indicating activity (a far-field target voice which may be that of the other talker 29 is active.) The transparency mode is sustained in this manner, in response to the own voice and the far-field target voice being detected. Here, a boundary is defined around a currently location of the wearer 27 as illustrated in FIG. 9b. Now, upon receiving a message 18 (see FIG. 2) that the wearer 27 has crossed (outside) the boundary as illustrated in FIG. 9c and based on detecting from the own voice that the wearer has stopped talking, e.g., for at least one second, the processor declares the conversation has ended (and so deactivates the transparency mode.) In other words, detecting that the wearer has stopped talking and the wearer has walked outside the boundary (FIG. 9c) suggests that the wearer 27 may no longer be conversing with the other talker 29. Using such a technique, the transparency mode is deactivated even while the processor is detecting from the far-field target voice that another person is talking-see FIG. 9c which shows others nearby having a separate conversation with each other.

In one aspect, the operations described above in connection with FIGS. 9a-9c, namely detecting the own voice, adjusting the conversation-focused transparency audio signal based on the detected own voice and based the detected far-field target voice, and the activation and deactivation of a transparency mode of operation may all be performed by the processor 15 in the headphone, while the following operations are performed by the companion device (see FIG. 2): determining a current location of the wearer while the transparency mode is active; defining the boundary around the current location; and detecting the wearer has crossed the boundary and in response sending the message 18 to the headphone over a wireless communication link, a BLUETOOTH link. In this manner, the processing and self-location and self-tracking capabilities of the companion device (e.g., the wearer's smartphone) can be leveraged to determine when the wearer has walked outside the boundary.

In another aspect, the transparency mode of operation may be activated during media playback (through the primary headphone 10a.—see FIG. 2) The processor 15 in that case may be configured to, during media playback and in response to the conversation being declared, segment the media playback signal to remove vocals therefrom thereby producing a background-only media playback signal. The processor would then duck the background-only media playback signal during the conversation.

In another aspect, there is a second processor in the secondary headphone 10b, that comprises a second filter block similar to the filter block 11, which is able to process one or more of microphone signals in the secondary headphone 10b, for producing a second conversation-focused transparency audio signal (the latter would be routed to a speaker of the secondary headphone 10b.) During playback of a multi-channel media playback signal, one or the other of these two processors is configured to, in response to the conversation detector declaring the conversation, downmix the multi-channel media playback signal into a mono media playback signal. The processor then renders the mono media playback signal by spatializing it out of the wearer's head (during the media playback.) In other words, when the conversation detector declares a conversation, the multi-channel media playback becomes spatialized into a single virtual sound source that is outside of the wearer's head, instead of simply pausing the playback.

In yet another media playback aspect, the processor is configured to pause or duck the media playback and then resume the media playback, in response to the conversation being declared and then ended, respectively.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

While certain aspects have been described and shown in the accompanying drawings, it is to be understood those are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

To aid the Patent Office and any readers of any patent issued on this application in interpreting the claims appended hereto, applicant wishes to note that it does not intend any of the appended claims or claim elements to invoke 35 U.S.C. 112 (f) unless the words “means for” or “step for” are explicitly used in the particular claim.

The following statements are based on the disclosure here.

20. A digital audio processor for use with a first headphone, the digital audio processor comprising:
a transparency signal processing path to filter a plurality of microphone signals of the first headphone, thereby producing a transparency audio signal; and
a conversation detector that processes i) one or more of the plurality of microphone signals and ii) one or more other sensor signals such as a bone conduction sensor signal, an accelerometer signal, or a gyroscope signal, of the first headphone, to
   declare a conversation, when a wearer of the first headphone is conversing with, or is about to converse with, a talker, and in response activate a transparency mode of operation, wherein in the transparency mode the processor activates the transparency audio signal and adjusts the transparency signal processing path based on detecting an own voice and a far-field target voice, and
   declare the conversation ended based on processing one or more of the microphone signals and the other sensor signals to detect the own voice and the far-field target voice.

21. The processor of statement 20 wherein the conversation detector declares the conversation ended based on i) comparing a detected gap after a word in the own voice, to an own voice threshold and ii) comparing a detected gap after a word in the target voice, to a target voice threshold.

22. The processor of statement 21 wherein the conversation detector updates the target voice threshold as stored in nonvolatile memory, based on determining a length of the conversation.

23. The processor of any one of statements 20-22 wherein the transparency audio signal is a conversation-focused transparency audio signal.

24. A method for headphone listening, the method comprising:
a) processing i) one or more of a plurality of microphone signals produced by a plurality of microphones in a headphone worn by a wearer, and ii) one or more other sensor signals [such as a bone conduction sensor signal, an accelerometer signal, a gyroscope signal, or an image sensor signal in the headphone], to detect an own voice;
b) in response to detecting in the own voice that the wearer is talking, activating a transparency mode of operation in which a transparency audio signal is produced;
c) adjusting the transparency audio signal based on detecting the own voice and based on detecting a far-field target voice through processing of one or more of the plurality of microphone signals and the one more other sensor signals;
d) sustaining the transparency mode, in response to the own voice and the far-field target voice being detected; and
e) deactivating the transparency mode based on receiving a message that the wearer has crossed a boundary around the wearer, and based on detecting from the own voice that the wearer has stopped talking for at least one second.

25. The method of statement 24 wherein a)-e) are performed by a processor in the headphone, the method further comprising the following operations performed by a companion device:
determining a current location of the wearer while the transparency mode is active;
defining the boundary around the current location; and
detecting the wearer has crossed the boundary and in response sending the message to the headphone over a wireless communication link.

26. The method of any one of statements 24-25 wherein the transparency mode is deactivated even while detecting from the far-field target voice that another person is talking.

27. The method of any one of statements 24-26 wherein the transparency audio signal is a conversation-focused transparency audio signal.

What is claimed is:

1. A digital audio processor for use with a first headphone, the digital audio processor comprising:
a filter block that is to process one or more of a plurality of microphone signals in the first headphone, for producing a transparency audio signal; and
a conversation detector that processes i) one or more of the plurality of microphone signals and ii) one or more other sensor signals being a bone conduction sensor signal, an accelerometer signal, a gyroscope signal, or an image sensor signal of the first headphone, to
declare a conversation and in response activate a transparency mode of operation, when a wearer of the first headphone is conversing with or is about converse with another talker who is in an ambient environment of the wearer,
wherein in the transparency mode, the processor configures the filter block to activate the transparency audio signal, and routes the transparency audio signal to a speaker of the first headphone, and
declare an end to the conversation based on processing one or more of the plurality of microphone signals and the other sensor signals, and in response deactivate the transparency mode,
wherein the conversation detector comprises an own voice activity detector, OVAD and a target voice activity detector, TVAD, monitors an idle duration in which the OVAD and the TVAD are both or simultaneously indicating no activity, and declares the end to the conversation in response to the idle duration being longer than an idle threshold, and wherein the conversation detector tracks a plurality of instances of an observed idle duration over several days, each instance being a length of time the transparency mode remains continuously inactive until activated, and varies the idle threshold based on the observed idle duration.

2. The processor of claim 1 wherein the conversation detector tracks the plurality of instances of the observed idle duration over several weeks, and varies the idle threshold based on monitoring the observed idle duration over several weeks.

3. The processor of claim 1 further configured to, during media playback through the first headphone and in response to the conversation detector declaring the conversation, segment a media playback signal to remove vocals therefrom thereby producing a background-only media playback signal, and duck the background-only media playback signal during the conversation.

4. The processor of claim 1 in combination with a second processor for use with a second headphone, wherein the second processor comprises a second filter block that is to process one or more of a plurality of microphone signal in the second headphone, for producing a second transparency audio signal that is routed to a speaker of the second headphone, a combination of the processor and the second processor being configured to:
during media playback through the first headphone and the second headphone, and in response to the conversation detector declaring the conversation, downmix a multi-channel media playback signal into a mono media playback signal and spatialize the mono media playback signal out of the wearer's head during the media playback.

5. The processor of claim 1 being further configured to, during media playback through the first headphone, pause or duck the media playback and then resume the media playback, in response to the conversation being declared and then ended, respectively.

6. The processor of claim 1 wherein the transparency audio signal is a conversation-focused transparency audio signal.

7. A method for headset audio processing, the method comprising:
generating a recommended aperture while a wearer of the headset is looking at a first direction;
producing a transparency audio signal that is to drive a speaker of the headset, wherein the transparency audio signal is produced by processing a plurality of microphone signals produced by a plurality of microphones in the headset, to perform speech enhancement or speech isolation within the recommended aperture;
expanding the recommended aperture in response to the wearer of the headset looking away from the first direction in a different, second direction; and then
shrinking the recommended aperture so long as the wearer of the headset continues to look in the second direction.

8. The method of claim 7 wherein the expanded recommended aperture encompasses the first direction and the second direction.

9. The method of claim 7 wherein the recommended aperture shrinks according to a decay parameter.

10. The method of claim 7 wherein the recommended aperture comprises a plurality of instances over time where each instance is generated based on a yaw angle history, a previous instance of the recommended aperture, and a decay parameter, wherein the yaw angle history comprises a plurality of instances over time of sensed yaw angle of the headset.

11. The method of claim 7 wherein processing the plurality of microphone signals, to perform speech enhancement or speech isolation within the recommended aperture, comprises a beamforming algorithm that suppresses sound pickup in directions that are outside of the recommended aperture.

12. The method of claim 7 wherein the expanded recommended aperture is one of a plurality of predetermined apertures.

13. The method of claim 7 wherein expanding the recommended aperture comprises using a machine learning model to analyze a yaw angle history, the yaw angle history comprising a plurality of instances over time of sensed yaw angle of the headset, to determine when to expand the recommended aperture or how to expand the recommended aperture.

14. The method of claim 7 wherein expanding the recommended aperture is in response to detecting a head tilt by the wearer.

15. The method of claim 7 wherein processing the plurality of microphone signals comprises using a machine learning (ML) model to perform speech enhancement or speech separation.

16. A method for headset audio signal processing, the method comprising:
generating an immediate aperture based on a yaw angle history,
wherein the yaw angle history comprises a plurality of instances over time of sensed yaw angle of a headset, and
wherein the immediate aperture comprises a plurality of instances over time where each instance encompasses one or more directions in which the user has looked [relative to a current head orientation yaw angle] during a period of interest;
generating a recommended aperture, wherein the recommended aperture comprises a plurality of instances over time where each instance is generated based on i) the immediate aperture, ii) a previous instance of the recommended aperture, and iii) a decay parameter; and
producing a transparency audio signal that is to drive a speaker of the headset, wherein the transparency audio signal is produced by applying a speech enhancement process or a speech isolation process to a plurality of microphone signals produced by a plurality of microphones, respectively, of the headset, based on the recommended aperture.

17. The method of claim 16 wherein the recommended aperture expands immediately whenever the user looks in a different direction to encompass the different direction, and otherwise shrinks at a rate that is in accordance with the decay parameter.

18. The method of claim 17 wherein the recommended aperture shrinks due to one or more old directions not being included in the recommended aperture, wherein the old directions are directions in which the user has looked prior to the period of interest.

19. The method of claim 18 wherein the recommended aperture shrinks but does not become smaller than a minimum non-zero aperture.

20. The method of claim 17 wherein the recommended aperture shrinks but does not become smaller than a minimum non-zero aperture.
